(19) United States
(12) Patent Application Publication
(10) Pub. No.: US 2013/0269979 A1
(43) Pub. Date: Oct. 17, 2013

(54) CABLE POSITIONING MECHANISM AND ELECTRONIC DEVICE USING THE SAME

(71) Applicant: XIAO-HUI ZHOU, Shenzhen City (CN)

(72) Inventor: XIAO-HUI ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,263

(22) Filed: Aug. 29, 2012

(30) Foreign Application Priority Data
Apr. 12, 2012 (CN) 201210105991.0

(51) Int. Cl. H01B 7/40

(52) U.S. Cl. 174/135

(57) ABSTRACT

A cable positioning mechanism to hold at least one cable in position includes a first sidewall, a second sidewall, and a third sidewall. The second sidewall and the third sidewall are respectively connected to opposite ends of the first sidewall. A first positioning member projects from the top of the first sidewall and extends in a direction substantially perpendicular to the first sidewall. A second positioning member projects from the top of the second sidewall, and a third positioning member projects from the top of the third sidewall. The first positioning member, the second positioning member, and the third positioning member cooperatively restrict the movement of the at least one cable.

### BACKGROUND

1. Technical Field

The present disclosure relates to positioning mechanisms, and particularly, to a cable positioning mechanism and an electronic device using the cable positioning mechanism.

2. Description of Related Art

An electronic device typically includes a variety of cables for electrically connecting different electronic components in the device. The cables in the electronic device may become tangled when the upper cover and the bottom cover are separated from each other by accident.

Therefore, what is needed is a means to solve the problems described above.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a partially disassembled isometric view of the electronic device in which an upper cover is omitted.

FIG. 2 is an isometric view of a cable positioning mechanism used in the electronic device of FIG. 1.

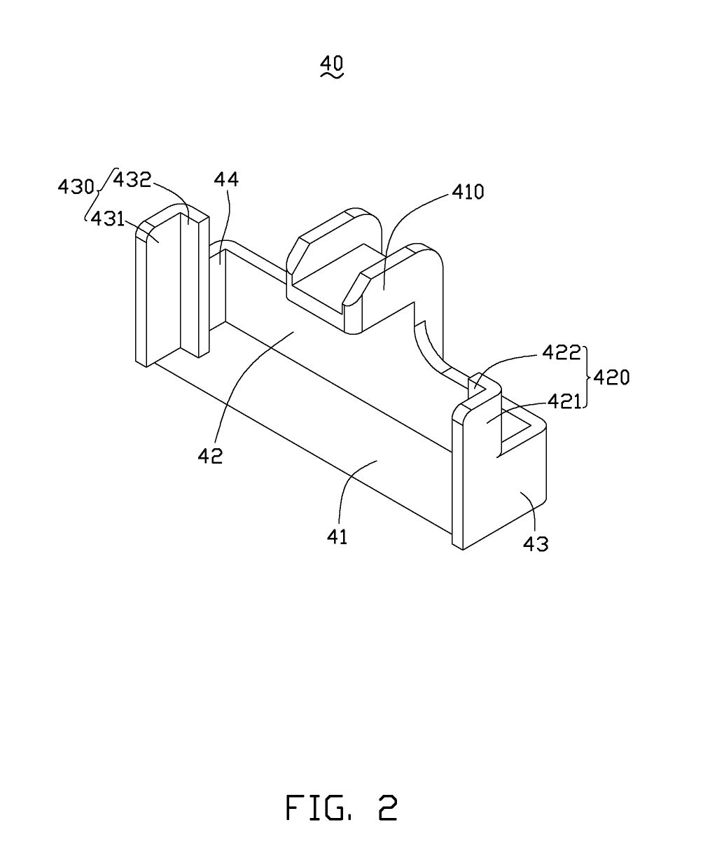

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

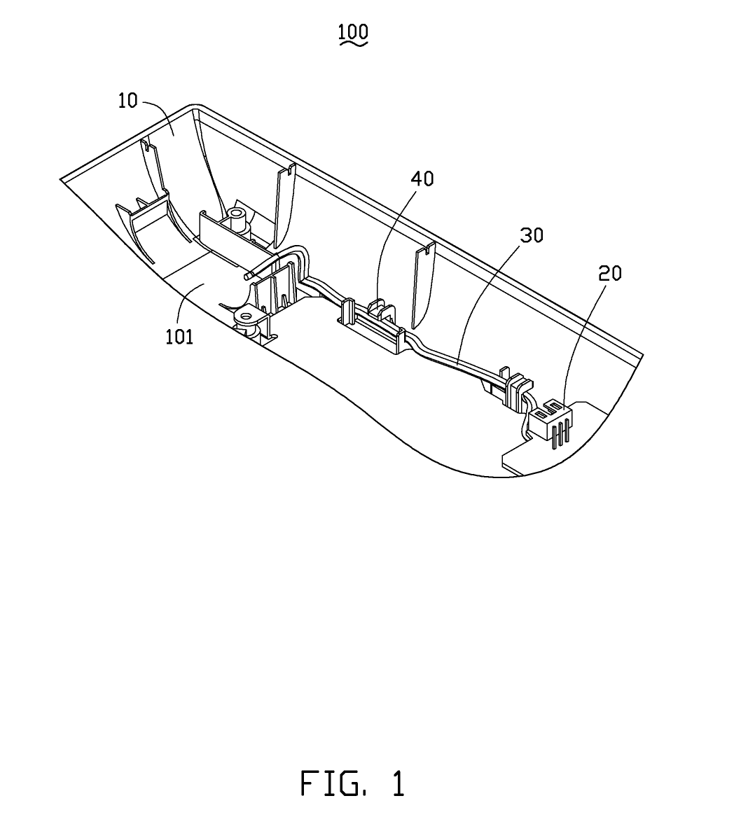

FIG. 1 is an exemplary embodiment of an electronic device 100 with an upper cover omitted for clarity. The electronic device 100 includes a bottom cover 10 defining a receiving space 101 for receiving at least one electronic component 20, at least one cable 30 including one end connected to the electronic component 20, and a cable positioning mechanism 40 for holding the cable 30. The cable positioning mechanism 40 is arranged on an inner surface of the bottom cover 10.

The positioning device 40 includes a bottom portion 41, a first sidewall 42, a second sidewall 43, and a third sidewall 44. The bottom portion 41 is fixed on the bottom cover 10. The first sidewall 42, the second sidewall 43, and the third sidewall 44 protrude from the bottom portion 41. The second sidewall 43 is parallel with the third sidewall 44, and the second sidewall 43 and the third sidewall 44 are respectively connected to opposite ends of the first sidewall 42.

A first positioning member 410 projects from the top of the first sidewall 42 and extends in a direction substantially perpendicular to the first sidewall 42. The first positioning member 410, the second sidewall 43, and the third sidewall 44 are all located on a same side of the first sidewall 42.

A second positioning member 420 is formed on the top of the second sidewall 43 and includes a first extending portion 421 and a first block portion 422. The first extending portion 421 projects from the top of the second sidewall 43 and is spaced a distance apart from the first sidewall 42. The first block portion 422 is connected to an end of the first extending portion 421 adjacent to the first sidewall 42. The first block portion 422 is substantially parallel to the first sidewall 42.

A third positioning member 430 is formed on the top of the third sidewall 44 and includes a second extending portion 431 and a second block portion 432. The second extending portion 431 projects from the top of the third sidewall 44 and is spaced a distance apart from the first sidewall 42. The second block portion 432 is connected to an end of the second extending portion 431 adjacent to the first sidewall 42. The second block portion 432 is substantially parallel to the first sidewall 42.

The cable 30 is placed on the top of second sidewall 43 and the third sidewall 44 and is restricted by the first positioning member 410, the first block portion 421, and the second block portion 431. That is, the movement of the cable 30 in a direction perpendicular to bottom portion 41 is restricted by the first positioning member 410, the second sidewall 43, and the third sidewall 44, and the movement of the cable 30 in a direction parallel to the bottom portion 41 is restricted by the first positioning member 410, the first block portion 422, and the second block portion 432.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A cable positioning mechanism for being attached to a cover of an electronic device and configured to hold at least one cable in position, the cable positioning mechanism comprising:
a first sidewall;
a second sidewall and a third sidewall respectively connected to opposite ends of the first sidewall;
a first positioning member projecting from a top of the first sidewall and extending in a direction substantially perpendicular to the first sidewall;
a second positioning member projecting from a top of the second sidewall; and
a third positioning member projecting from a top of the third sidewall;
wherein the first positioning member, the second positioning member, and the third positioning member cooperatively restrict movement of the at least one cable.

2. The cable positioning mechanism as described in claim 1, further comprising a bottom portion to be attached on the cover of the electronic device, wherein the first sidewall, the second sidewall, and the third sidewall are connected to the bottom portion.

3. The cable positioning mechanism as described in claim 1, wherein the second positioning member comprises a first extending portion and a first block portion, the first extending portion projects from the top of the second sidewall and is spaced a distance apart from the first sidewall, the first block portion is connected to an end of the first extending portion adjacent to the first sidewall, the first block portion is substantially parallel to the first sidewall.

4. The cable positioning mechanism as described in claim 1, wherein the third positioning member comprises a second extending portion and a second block portion, the second extending portion projects from the top of the third sidewall and is spaced a distance apart from the first sidewall, the second block portion is connected to an end of the second extending portion adjacent to the first sidewall, the second block portion is substantially parallel to the first sidewall.

5. An electronic device, comprising:
a bottom cover defining a receiving space;
a cable positioning mechanism received in the receiving space and configured to hold at least one cable in position, the cable positioning mechanism comprising:
a first sidewall;
a second sidewall and a third sidewall respectively connected to opposite ends of the first sidewall;
a first positioning member projecting from a top of the first sidewall and extending in a direction substantially perpendicular to the first sidewall;
a second positioning member projecting from a top of the second sidewall; and
a third positioning member projecting from a top of the third sidewall;
wherein the first positioning member, the second positioning member, and the third positioning member cooperatively restrict a movement of the at least one cable.

6. The electronic device as described in claim 5, wherein the cable positioning mechanism further comprises a bottom portion fixed on the cover of the electronic device, the first sidewall, the second sidewall, and the third sidewall protrude from the bottom portion.

7. The electronic device as described in claim 5, wherein the second positioning member comprises a first extending portion and a first block portion, the first extending portion projects from the top of the second sidewall and is spaced a distance apart from the first sidewall, the first block portion is connected to an end of the first extending portion adjacent to the first sidewall, the first block portion is substantially parallel to the first sidewall.

8. The electronic device as described in claim 5, wherein the third positioning member comprises a second extending portion and a second block portion, the second extending portion projects from the top of the third sidewall and is spaced a distance apart from the first sidewall, the second block portion is connected to an end of the second extending portion adjacent to the first sidewall, the second block portion is substantially parallel to the first sidewall.
